(19) United States
(12) Patent Application Publication
(10) Pub. No.: US 2005/0225277 A1
(43) Pub. Date: Oct. 13, 2005

(54) Gate supervising system

(76) Inventors: Jean-Francois Savard, Baie-Comeau (CA); Jacques Parent, Baie-Comeau (CA); Claude Mercier, Baie-Comeau (CA)

Correspondence Address: INVENTARIUM;Suite 1607, 4050 Rosemont blvd, Montreal, H1X 1M4, CA

(21) Appl. No.: 11/054,865

(22) Filed: Feb. 10, 2005

Related U.S. Application Data
(60) Provisional application No. 60/543,257, filed on Feb. 10, 2004.

(51) Int. Cl. H02P 1/04; H02P 3/00

(52) U.S. Cl. 318/478; 318/482

(57) ABSTRACT

A gate supervising system takes over the control of the motors operating the gates in order to prevent costly damage to the gates. A processor and an input interface to receive data from physical constraints sensors; a voltage/current sensor related to the opening and closing of the gates; status of a temperature sensor; a waterlevel sensor; an output interface leading to the gates controls as well as a fault indicator and alarm; a communication interface; and an operator's interface which comprises a computer with software.

This application claims priority based on provisional application 60/543,257 filed Feb. 10, 2004

### BACKGROUND OF THE INVENTION

1. Field of the Invention

The invention relates generally to control system but more particularly to a gate supervising system that monitors the operational status of gates and water level at a reservoir in the context of dams.

2. Background of the Invention

There are many systems aimed at managing the operations of dams, whether water control dams or hydroelectric dams.

One system for a hydroelectric dam handles the load on the turbine-generator units to match it with the flow of the river so that the units operate at the maximum head available for existing flow conditions to produce the maximum energy available from the river flow for the installed capacity of the plant and within the allowable, safe operating capability range of the turbine-generator units. Reservoir water level sensors provide a signals indicating a change in water level, sensors for generator electrical and thermal operating characteristics provide a signals related thereto, and a control connected to the water level sensors, to the generator sensors and to the turbine governor adjusts the turbine flow control devices to change the turbine power in response to changing river level within the safe and allowable operating range of the generator.

An integrated control system for a power plant having a generator, a turbine, a gate for controlling flow through the turbine, a voltage regulator, a bus and a main circuit breaker. The control system comprises a nonvolatile memory for storing configuration data that includes a plurality of configuration parameters for the power plant. The control system further includes input devices for producing input data concerning current plant conditions including turbine speed, gate position, generator current and voltage, bus current and voltage, and the position of the main circuit breaker. A multi-tasking processor processes the input data in accordance with the configuration data, to produce control signals for controlling the power plant.

A system for monitoring maintenance information in a hydroelectric power generation facility comprises sensors coupled to a controller. The sensors detect actual levels of operating parameters for a desired operating period at an operating condition. The detected parameters include a stressor capable of affecting a life span, or mean time between failures, of the turbine or one of its components. The controller determines the amount of the life span used up. A method for monitoring losses in a hydroelectric power generation facility operating to satisfy environmental constraints involves storing predetermined reference signals representative of desired turbine efficiencies over a range of operating levels in a memory circuit. Current levels of operating parameters are sensed while the facility is operating to satisfy the environmental constraints.

The operation of dams is a complex undertaking and with various factors such as water shortage due in part to fluctuations in weather patterns, this operation has become even more complex since managing the flow of water in the reservoir behind the gate can at time become highly critical. The foregoing systems lack critical features which makes their functionality as gate management systems rather weak. There is therefore a need for an efficient and safe system for gate management of hydroelectric dams.

### SUMMARY OF THE INVENTION

In view of the foregoing disadvantages inherent in the known devices now present in the prior art, the present invention, which will be described subsequently in greater detail, is to provide objects and advantages which are:
Detection of the blockage of a gate.
Detection of the blockage of the opening or closing mechanism.
Detection of risk in opening or closing in cold weather.
Prediction of a blockage during opening or closing of a gate.
Detection of a brownout in the electrical supply to the motor.
Three phase electrical supply fluctuations.
Unevenness of strain between the two gauges.
Keep records of all the foregoing operations to insure proper maintenance of the gates and their mechanism.

To attain these ends, the present invention generally comprises:

A processor and an input interface to receive data from physical constraints sensors; a voltage/current sensor related to the opening and closing of the gates; status of a temperature sensor; a water level sensor; an output interface leading to the gates controls as well as a fault indicator and alarm; a communication interface; and an operator's interface which comprises a computer with software.

The gate supervising system takes over the control of the motors operating the gates in order to prevent costly damage to the gates. For example, the gates won't be activated if the temperature is too low. The gate supervising system can also transmit its data remotely.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

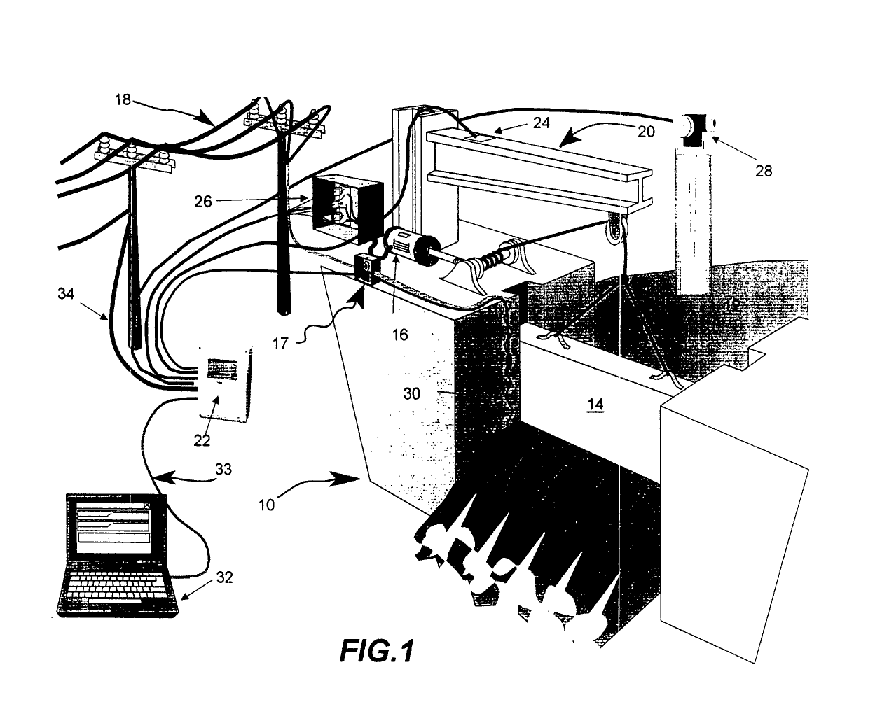

FIG. 1 Perspective view of the components in context.

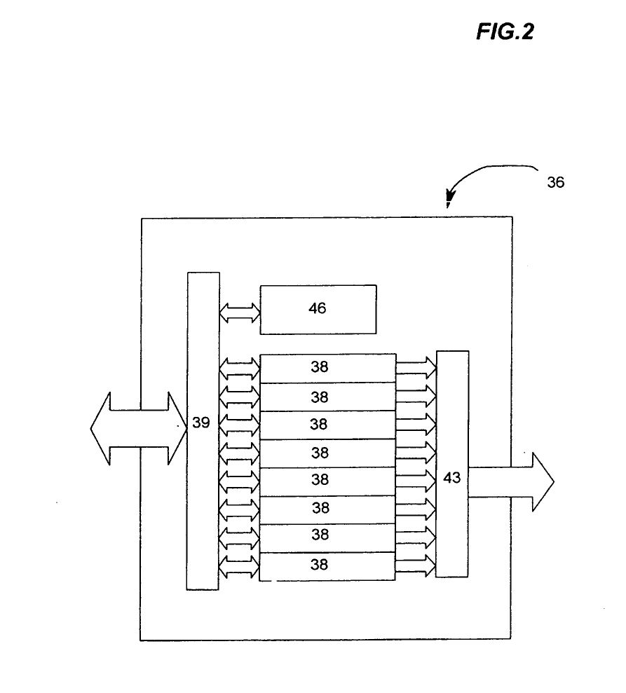

FIG. 2 Schematic diagram of an output relays expansion card.

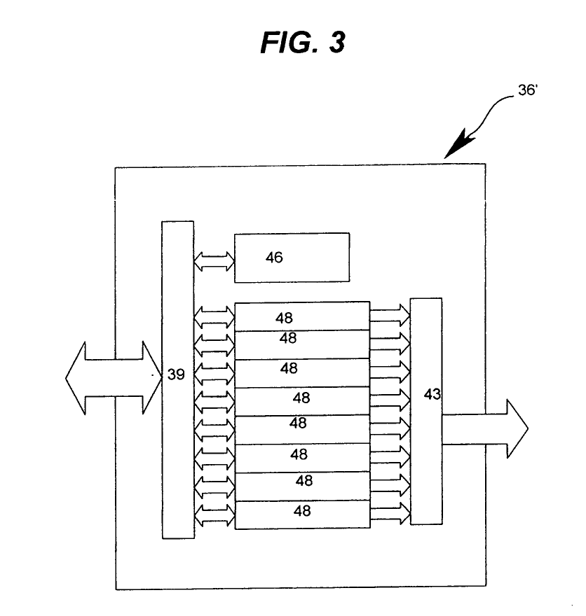

FIG. 3 Schematic diagram of a dry contacts expansion card.

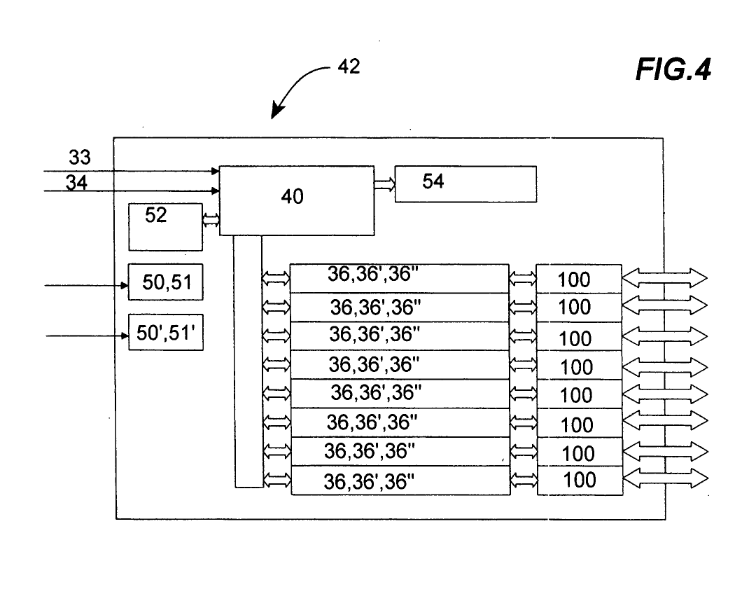

FIG. 4 Schematic diagram of the motherboard.

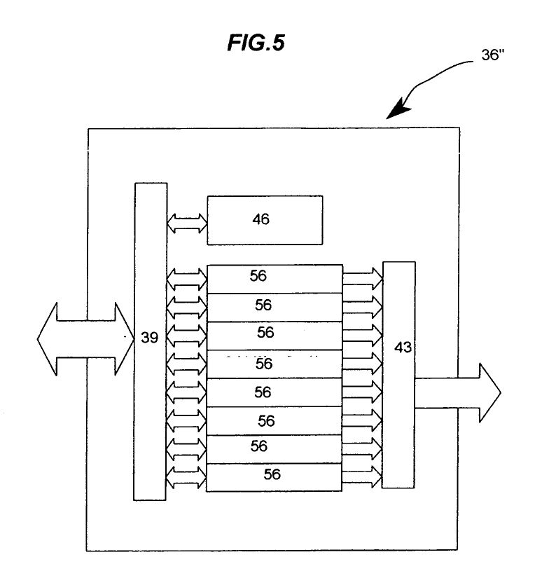

FIG. 5 Schematic diagram of an analog inputs expansion card.

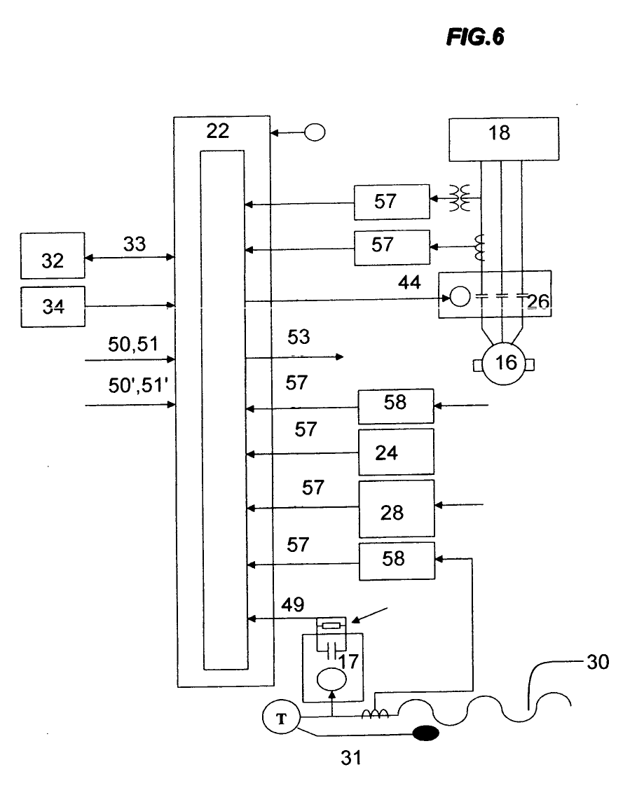

FIG. 6 Schematic diagram of the components shown in FIG. 1.

### DETAILED DESCRIPTION OF THE PREFERRED EMBODIMENT

FIG. 1A dam (10) holding a reservoir (12) has a gate (14) which is lifted by way of an electric motor (16) powered by 3 phase voltage (18), when using a 600 volts or higher motor, and a structural lift (20). An input interface (22) collects information from at least one constraint gauge (24) situated on the structural lift (20), voltage and current data from voltage and current sensors (26), a water level gauge (28) to collect data about water level behind the dam (10). A heating cable (30) with a relay with a thermostat (31) (shown in FIG. 6) to supervise tension in the heating cable (30) to insure that the gate (14) will not freeze at the junction with the dam (10) during opening. That data is fed to a computer (32) by way of a USB connection (33) for analysis and monitoring, the data can be transmitted remotely via an Ethernet network connection (34). Of course, more efficient means of transferring data may be developped in the future.

FIG. 2 An expansion card for output relays (36) uses transistors instead of electromechnical relays since this system is designed to work under extreme temperature variations (−40° C. to +80° C.) and should operate on AC as well as on DC. Eight normally open (NO) contacts (38) can be configured via software to become normally closed contacts if required. A microprocessor (40) situated on a motherboard (42) controls the opening and closing of the gate (14) via a data and address bus (39). An EEPROM (46) is used for identifying the expansion card for output relays (36) and describes its features to the motherboard (42) by communicating to the motherboard (42) by way of its I/O tie point block bus (43). The motherboard (42) can thus identify this and other of the plurality of expansion cards (36′, 36″, etc) installed and interact with it.

FIG. 3A dry contacts expansion card (36′) has digital inputs (48) to read the state of the dry contacts (not shown). The digital inputs (48) can identify three states, a closed contact state, an open contact state, and a cut wire state which is determined by way of the absence of a known value end of line resistance set up to identify an open contact. (for example 10 Kohm provided by a voltage of less than 16 Vcc).

FIG. 4 The motherboard (42) supports all the expansion cards (36, 36′, 36″, etc) and has two power source, a standard 100-250 Vca/Vcc (50) or 18-26 Vcc (51) and an emergency power supply of 100-250 Vca/Vcc (50′) or 18-26 Vcc (51′). The microprocessor (40) acquires and stores data in memory (52). Data can be retrieved by Ethernet port (34) or USB port (33) by a computer (32). The retrieved and stored data has a date and time stamp for statistical purposes. The microprocessor (40) communicates with a plurality of expansion cards (36, 36′, 36″, etc), some of which have been described above. An LCD screen (54) shows results or alarm descriptions (53). Each expansion card (36, 36′, 36″) has its own tie down block (100).

FIG. 5 Analog inputs expansion card (36″) reads analog input currents (56) from the 4-20 mA loops (57, seen in FIG. 6). The 4-20 mA loops (57) operate on 20 a 26 Vcc. An override protection prevents current overloads by shutting down current for 0.1 of a second, after which, current is reestablished. This will reoccur as long as current does not drop below 40 mA. The current reading is done by way of a DA converter (58) with a high sampling rate.

FIG. 6 This schematic figure represents schematically the elements found on FIG. 1 plus a thermostat (31) for the heating cable (30) not shown in FIG. 1. Also, 4-20 mA loops (57) of FIG. 6.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A gate supervising system for dam comprising:
at least one structural lift and at least one electric motor to lift at least one gate;
at least one constraint gauge situated on said structural lift collecting data;
voltage and current sensors collecting voltage and current data;
a water level gauge to collect data about water level behingd said dam said data being fed to a computer for analysis and monitoring;
a motherboard having a microprocessor and support for expansion cards;
expansion cards to control operations of said gate via a data and address bus connecting to said expansion cards;
said expansion cards having I/O tie point block bus, and an EEPROM used for identifying said expansion cards and describing its features to said motherboard;
said expansion cards having three varieties which are output relays expansion card for relays; dry contacts expansion cards to read digital inputs to identify three states, a closed contact state, an open contact state, and a cut wire state; and analog inputs expansion cards to read analog input currents from 4-20 mA loops.

2. A gate supervising system for dam as in claim 1 wherein:
said motherboard having two power source, a standard power supply and an emergency power supply.

3. A gate supervising system for dam as in claim 1 wherein:
said microprocessor acquiring and storing data in memory.

4. A gate supervising system for dam as in claim 1 wherein:
a heating cable with a relay with a thermostat to supervise tension in the heating cable to insure that the gate will not freeze at the junction with said dam during opening.

5. A gate supervising system for dam as in claim 1 wherein:
an override protection to prevent current overloads by shutting down current for 0.1 of a second, after which, current is reestablished for as long as current does not drop below 40 mA.
